(19) United States
(12) Patent Application Publication
(10) Pub. No.: US 2025/0350803 A1
(43) Pub. Date: Nov. 13, 2025

(54) ARTIFICIAL INTELLIGENCE-BASED CHANNEL FEATURE RECOMMENDATIONS FOR A CHANNEL MEMBERSHIP ON A CONTENT PLATFORM

(71) Applicant: Google LLC, Mountain View, CA (US)

(72) Inventors: Pedro Maria de Bivar Black Henriques, Pfäffikon (CH); Ludmila Danilescu, Zurich (CH); Dhruv Bakshi, Zug (CH); Shu Li, Zurich (CH); Silviu Bota, Horgen (CH); Briana Yvonne Seiderman, Zurich (CH)

(21) Appl. No.: 19/204,274

(22) Filed: May 9, 2025

Related U.S. Application Data
(60) Provisional application No. 63/645,816, filed on May 10, 2024.

(51) Int. Cl. H04N 21/466; H04N 21/266; H04N 21/431; H04N 21/442

(52) U.S. Cl. CPC H04N 21/4668; H04N 21/266; H04N 21/431; H04N 21/44204

(57) ABSTRACT

Systems and methods for artificial intelligence-based channel feature recommendations for a channel membership on a content platform are provided. It is determined that a channel of a channel owner is associated with a channel membership. A plurality of engagement signals associated with the channel of the channel owner is identified. The plurality of engagement signals and a plurality of channel membership features are fed as input to a trained AI model. One or more outputs are obtained from the trained AI model, the one or more outputs indicating a number of additional channel members that is predicted to be added to the channel membership upon integration of a respective channel membership feature into the channel membership. A first channel membership feature recommendation for the channel membership is determined. A channel UI is caused to be presented to the channel owner, the channel UI providing the first channel membership feature recommendation.

### RELATED APPLICATIONS

This application claims the benefit of priority from U.S. Provisional Application No. 63/645,816, filed May 10, 2024, which is incorporated herein by reference.

### TECHNICAL FIELD

Aspects and implementations of the present disclosure relate to artificial intelligence-based channel feature recommendations for a channel membership on a content platform.

### BACKGROUND

A platform (e.g., a content platform) can transmit media items to client devices connected to the platform via a network. A media item can include an audio item or a video item, in some instances. Users can consume the transmitted media items via a user interface (UI) provided by the platform. In some instances, media items can be provided to users through channels. A channel can include content provided by a channel owner. A user can subscribe to the channel to gain access to the media items of the channel. In some instances, a channel owner can provide channel memberships offering various channel features, where a user can subscribe to the channel membership and gain access to the various channel features.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes determining, by a processing device of a content sharing platform, that a channel of a channel owner is associated with a channel membership. The method further includes identifying a plurality of engagement signals associated with the channel of the channel owner. The method further includes feeding, as input to a trained artificial intelligence (AI) model, the plurality of engagement signals and a plurality of channel membership features. The method further includes obtaining one or more outputs from the trained AI model, the one or more outputs indicating a number of additional channel members that is predicted to be added to the channel membership upon integration of a respective channel membership feature of the plurality of channel membership features into the channel membership. The method further includes determining, based on the one or more outputs from the trained AI model, a first channel membership feature recommendation for the channel membership. The method further includes causing a channel user interface (UI) of the content sharing platform to be presented to the channel owner, the channel UI providing the first channel membership feature recommendation for the channel membership of the channel.

In some implementations, causing the channel UI to be presented to the channel owner further includes causing the first channel membership feature recommendation to be displayed for the channel membership; and receiving a selection of one or more UI elements of the channel UI by the channel owner, wherein the one or more UI elements are selectable to modify one or more channel membership features for the channel membership based on the first channel membership feature recommendation.

In some implementations, the method further includes assigning a weight value to each engagement signal of the plurality of engagement signals; and determining, based on the weight value assigned to each engagement signal of the plurality of engagement signals, a respective ranking.

In some implementations, the plurality of engagement signals comprises at least one or more of: a number of channel subscribers, a number of views of the channel, a type of channel content, a geographic location of one or more subscribers associated with the channel owner, a geographic location of the channel owner, an amount of watch time associated with the channel, or one or more actions performed with respect to the plurality of channel features of the channel membership.

In some embodiments, the method further includes determining, based on the one or more outputs from the trained AI model, a second channel membership feature recommendation for the channel membership, wherein the second channel membership feature recommendation comprises a feedback on one or more of the plurality of channel membership features of the channel membership; and causing the channel UI to provide the second channel membership feature recommendation for the channel membership.

In some implementations, the method further includes determining, based on the one or more outputs from the trained AI model, a third channel membership feature recommendation for the channel membership, wherein the third channel membership feature recommendation comprises channel membership revenue information for one or more of the plurality of channel membership features of the channel membership; and causing the channel UI to provide the third channel membership feature recommendation for the channel membership.

In some implementations, wherein the first channel membership feature recommendation comprises one or more additional channel membership features to provide for the channel membership, wherein the one or more additional channel membership features correspond to an increase in channel members of the channel membership.

An aspect of the disclosure provides a system including a memory device and a processing device communicatively coupled to the memory device. The processing device performs operations including determining that a channel of a channel owner of a content sharing platform is associated with a channel membership. The processing device is to perform operations further including identifying a plurality of engagement signals associated with the channel of the channel owner. The processing device is to perform operations further including feeding, as input to a trained artificial intelligence (AI) model, the plurality of engagement signals and a plurality of channel membership features. The processing device is to perform operations further including obtaining one or more outputs from the trained AI model, the one or more outputs indicating a number of additional channel members that is predicted to be added to the channel membership upon integration of a respective channel membership feature of the plurality of channel membership features into the channel membership. The processing device is to perform operations further including determining, based on the one or more outputs from the trained AI model, a first channel membership feature recommendation for the channel membership. The processing device is to perform operations further including causing a channel user interface (UI) of the content sharing platform to be presented to the channel owner, the channel UI providing the first channel membership feature recommendation for the channel membership of the channel.

In some implementations, to cause the channel UI to be presented to the channel owner, the processing device is to perform operations further including causing the first channel membership feature recommendation to be displayed for the channel membership; and receiving a selection of one or more UI elements of the channel UI by the channel owner, wherein the one or more UI elements are selectable to modify one or more channel membership features for the channel membership based on the first channel membership feature recommendation.

In some implementations, the processing device is to perform operations further including assigning a weight value to each engagement signal of the plurality of engagement signals; and determining, based on the weight value assigned to each engagement signal of the plurality of engagement signals, a respective ranking.

In some implementations, wherein the plurality of engagement signals comprises at least one or more of: a number of channel subscribers, a number of views of the channel, a type of channel content, a geographic location of one or more subscribers associated with the channel owner, a geographic location of the channel owner, an amount of watch time associated with the channel, or one or more actions performed with respect to the plurality of channel features of the channel membership.

In some embodiments, the processing device is to perform operations further including determining, based on the one or more outputs from the trained AI model, a second channel membership feature recommendation for the channel membership, wherein the second channel membership feature recommendation comprises a feedback on one or more of the plurality of channel membership features of the channel membership; and causing the channel UI to provide the second channel membership feature recommendation for the channel membership.

In some implementations, the processing device is to perform operations further including determining, based on the one or more outputs from the trained AI model, a third channel membership feature recommendation for the channel membership, wherein the third channel membership feature recommendation comprises channel membership revenue information for one or more of the plurality of channel membership features of the channel membership; and causing the channel UI to provide the third channel membership feature recommendation for the channel membership.

In some implementations, wherein the first channel membership feature recommendation comprises one or more additional channel membership features to provide for the channel membership, wherein the one or more additional channel membership features correspond to an increase in channel members of the channel membership.

An aspect of the disclosure provides a computer program including instructions that, when the program is executed by a processing device, cause the processing device to perform operations including determining that a channel of a channel owner of a content sharing platform is associated with a channel membership. The processing device is to perform operations further including identifying a plurality of engagement signals associated with the channel of the channel owner. The processing device is to perform operations further including feeding, as input to a trained artificial intelligence (AI) model, the plurality of engagement signals and a plurality of channel membership features. The processing device is to perform operations further including obtaining one or more outputs from the trained AI model, the one or more outputs indicating a number of additional channel members that is predicted to be added to the channel membership upon integration of a respective channel membership feature of the plurality of channel membership features into the channel membership. The processing device is to perform operations further including determining, based on the one or more outputs from the trained AI model, a first channel membership feature recommendation for the channel membership. The processing device is to perform operations further including causing a channel user interface (UI) of the content sharing platform to be presented to the channel owner, the channel UI providing the first channel membership feature recommendation for the channel membership of the channel.

In some implementations, to cause the channel UI to be presented to the channel owner, the processing device is to perform operations further including causing the first channel membership feature recommendation to be displayed for the channel membership; and receiving a selection of one or more UI elements of the channel UI by the channel owner, wherein the one or more UI elements are selectable to modify one or more channel membership features for the channel membership based on the first channel membership feature recommendation.

In some implementations, the processing device is to perform operations further including assigning a weight value to each engagement signal of the plurality of engagement signals; and determining, based on the weight value assigned to each engagement signal of the plurality of engagement signals, a respective ranking.

In some implementations, wherein the plurality of engagement signals comprises at least one or more of: a number of channel subscribers, a number of views of the channel, a type of channel content, a geographic location of one or more subscribers associated with the channel owner, a geographic location of the channel owner, an amount of watch time associated with the channel, or one or more actions performed with respect to the plurality of channel features of the channel membership.

In some embodiments, the processing device is to perform operations further including determining, based on the one or more outputs from the trained AI model, a second channel membership feature recommendation for the channel membership, wherein the second channel membership feature recommendation comprises a feedback on one or more of the plurality of channel membership features of the channel membership; and causing the channel UI to provide the second channel membership feature recommendation for the channel membership.

In some implementations, the processing device is to perform operations further including determining, based on the one or more outputs from the trained AI model, a third channel membership feature recommendation for the channel membership, wherein the third channel membership feature recommendation comprises channel membership revenue information for one or more of the plurality of channel membership features of the channel membership; and causing the channel UI to provide the third channel membership feature recommendation for the channel membership.

In some implementations, wherein the first channel membership feature recommendation comprises one or more additional channel membership features to provide for the channel membership, wherein the one or more additional channel membership features correspond to an increase in channel members of the channel membership.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 depicts a flow diagram of a method for identifying, using artificial intelligence, channel feature recommendations for a channel membership on a content platform, in accordance with implementations of the present disclosure.

FIG. 3A is a block diagram illustrating an example channel user interface (UI), in accordance with implementations of the present disclosure.

FIG. 3B is a block diagram illustrating another example channel user interface (UI), in accordance with implementations of the present disclosure.

FIG. 4 depicts a flow diagram of a method for training an artificial intelligence (AI) model, in accordance with implementations of the present disclosure.

FIG. 5 is a block diagram illustrating an exemplary computer system, in accordance with implementations of the present disclosure.

### DETAILED DESCRIPTION

Aspects of the present disclosure relate to artificial intelligence-based channel feature recommendations for a channel membership on a content platform.

A platform (e.g., a content sharing platform) can transmit media items to client devices connected to the platform via a network. A media item can include an audio item or a video item, in some instances. Users can consume the transmitted media items via a user interface (UI) provided by the platform. In some instances, media items can be provided to users through channels.

A channel can include content available from a common source and/or having a common topic or theme. A channel can be managed by the channel owner who can perform various management actions on the channel. Management actions may include, for example, adding media items to the channel, removing media items from the channel, defining subscription requirements for the channel, defining presentation attributes for channel content, defining access attributes for channel content, etc. The channel content can include media items uploaded to the content platform by the channel owner and/or media items selected by the channel owner from content available on the content platform. A channel owner can be, e.g., a professional content provider (e.g., a professional content creator, a professional content distributor, a content rental service, a television (TV) service, etc.), or an amateur individual. The channel content can include, e.g., professional content (e.g., movie clips, TV clips, music videos, educational videos) and/or amateur content (e.g., video blogging, short original videos, etc.).

Users of the platform can subscribe to one or more channels in which they are interested. Typically, subscribing to a channel provides users with free access to content (e.g., channel features) on the channel. In some instances, a channel owner may be interested in monetizing the channel by making some or all of the content (e.g., channel features) on the channel available to users who have a paid subscription to the channel (e.g., a channel membership). However, when providing a channel membership, the channel owner may not be able to select the channel features for offering to subscribers, such that the selected channel features would maximize the revenue-driving parameters of the channel (e.g., the number of channel members, revenue, viewership, etc.).

Implementations of the present disclosure address the above and other deficiencies by identifying, using artificial intelligence, and presenting to the channel owner the channel membership feature recommendations for a channel membership of a channel of the channel owner that are likely to maximize the revenue-driving parameters of the channel (e.g., the number of channel members, revenue, viewership, etc.). One or more channel features of the channel membership feature recommendations can be integrated (e.g., by the channel owner) into the channel membership of the channel of the channel owner. In some embodiments, the channel membership feature recommendations can include feedback on the existing channel features provided (e.g., by the channel owner) for the channel membership of the channel, such that the channel owner can select to continue providing one or more of the existing channel membership features or choose to remove one or more of the existing channel membership features (e.g., to maximize the revenue-driving parameters of the channel). In some embodiments, the channel membership feature recommendations can include channel membership revenue information for a set of channel membership features, such that the channel owner can select one or more of the set of channel membership features to integrate into the channel membership for the channel of the channel owner (e.g., to maximize the revenue-driving parameters of the channel). In some embodiments, the channel features can include, for example, channel member loyalty badges, early access to content, channel members-only content, prioritization of channel owner's response to comments from channel members, channel members “shout-outs,” channel members status updates using media (e.g., images), channel members-only chat rooms, channel members-only social media connection with channel owner, channel members-only emojis, etc.

In some embodiments, the channel membership feature recommendations can be determined using a trained artificial intelligence (AI) model. For example, a set of engagement signals of the channel of the channel owner and a set of channel membership features can be fed as input to the trained AI model. In some embodiments, the engagement signals can include the number of subscribers of the channel owner, the geographic regions in which the subscribers of the channel reside, the age group of the subscribers of the channel, the content type of the channel owner, the media type of the channel owner (e.g., livestream content, short form media, long form media, etc.), etc.). One or more outputs can be obtained from the trained AI model, where the one or more outputs can indicate the number of additional channel members that would be added to the channel membership of the channel of the channel owner if a respective channel membership feature is integrated into the channel membership (e.g., provided to channel members of the channel membership). Based on the one or more outputs from the trained AI model, one or more channel membership feature recommendations can be determined (e.g., by identifying the one or more channel membership feature recommendations that correspond to the highest number of additional channel members that would be added to the channel membership if the one or more channel membership feature recommendations is integrated into the channel membership).

In some embodiments, the channel user interface (UI) can be presented to the channel owner. The channel UI can provide the channel membership feature recommendations for the channel membership of the channel. The channel owner can then select one or more UI elements of the channel UI to select any of the determined channel membership feature recommendations to modify one or more channel membership features (e.g., pre-existing channel membership features) for the channel membership of the channel of the channel owner, e.g., to integrate the selected determined channel membership feature recommendation into the channel membership. In some embodiments, the channel UI can be modified to display information about the selected channel membership feature recommendations, e.g., the information can include details and/or tips on how to integrate the selected channel membership feature recommendation into the channel membership.

Thus, aspects of the present disclosure provide technical advantages over previous solutions. Aspects of the present disclosure can provide an automated tool that uses a trained artificial intelligence model for identifying channel membership features for a channel membership for a particular channel. Such an automated tool can be integrated into various services, such as content sharing platforms. Furthermore, recommending channel features can encourage the channel owner to offer certain channel membership features in channel membership to subscribers, which can result in longer user sessions, higher user interaction rates, etc., on the content platform.

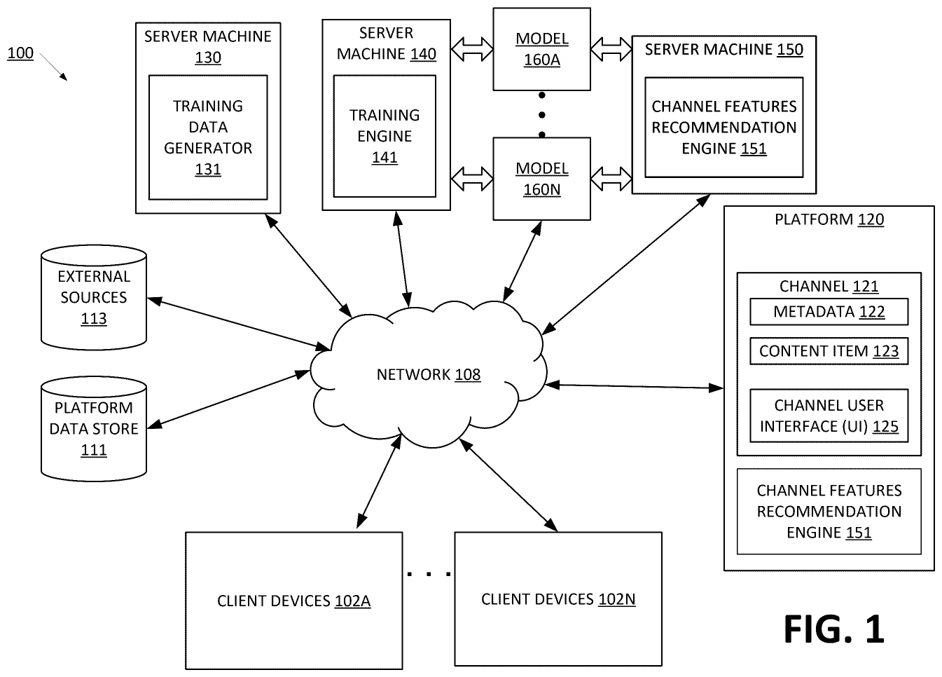

FIG. 1 illustrates an example system 100, in accordance with implementations of the present disclosure. The system 100 includes user devices 102A-N, a platform data store 111, a platform 120, a server machine 130, a server machine 140, and/or a server 150, each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, platform data store 111 can be a persistent storage capable of storing data as well as data structures to tag, organize, and index the platform data. In some implementations, a data item of platform data can correspond to one or more portions of a content item for display to a content viewer via a graphical user interface (GUI) on a viewing user device 102, in accordance with implementations described herein. A data item can correspond to metadata for a content item, such as a content item title, transcript, description, length, or content item viewing statistics. In some implementations, a data item of platform data can correspond to one or more portions of a channel, including channel metadata such as a channel title, channel description, channel uploading user, or channel viewing statistics. Platform data store 111 can be hosted by one or more storage devices, such as main memory, magnetic or optical storage-based disks, tapes or hard drives, NAS, SAN, and so forth. In some implementations, platform data store 111 can be a network-attached file server, while in other implementations the platform data store 111 can be some other type of persistent storage such as an object-oriented database, a relational database, and so forth, that may be hosted by platform 120 or one or more different machines coupled to the platform 120 via network 108.

The client devices 102A-N can each include computing devices such as personal computers (PCs), laptops, mobile phones, smartphones, tablet computers, netbook computers, network-connected televisions, etc. Each client device 102 can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital content items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital content items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers can be embedded media players that are embedded in web pages provided by the platform 120.

Platform 120 can include one or more channels 121. A channel 121 can include metadata 122 associated with the channel 121, and one or more content items 123 available from a common source, or content items 123 having a common topic, theme, or substance. Metadata 122 can include various information pertinent to the channel 121, such as a title, description, date, usage statistics, or content language. In some implementations, metadata 122 can include information about the one or more content items 123 of channel 121. For example, metadata 122 can include information about content item 123, such as a title, description, date, identity of channel owner, usage statistics, or language.

A channel 121 can represent one or more content item 123 (e.g., digital content) chosen by a user, digital content made available by a user, digital content uploaded by a user, digital content chosen by a content provider, digital content chosen by a broadcaster, etc. For example, a channel X can include videos Y and Z. A channel can be associated with a channel owner, who is a user that can perform actions on the channel. Different activities can be associated with the channel 121 based on the channel owner's actions, such as the channel owner making digital content available on the channel 121, the channel owner selecting (e.g., liking) digital content associated with another channel 121, the channel owner commenting on digital content associated with another channel 121, etc. The activities associated with the channel 121 can be collected into an activity feed for the channel 121. Users, other than the owner of the channel 121, can subscribe to one or more channels 121 in which they are interested. The concept of “subscribing” may also be referred to as “liking,” “following,” “friending,” and so on.

A content item 123 can be consumed via the Internet or via a mobile device application, such as a content viewer of viewing client devices 102A-N. In some implementations, a content item 123 can correspond to a media file (e.g., a video file, an audio file, a video stream, an audio stream, etc.). In other or similar implementations, a content item 123 can correspond to a portion of a media file (e.g., a portion or a chunk of a video file, an audio file, etc.). As discussed previously, a content item 123 can be requested for presentation to the user by the user of the platform 120. As used herein, “content item” can include an electronic file that can be executed or loaded using software, firmware or hardware configured to digitally present the content item to an entity. As indicated above, in at least one implementation, the platform 120 can store the content items 123, or references to the content items 123, using the platform data store 111. In some implementations, the platform 120 can store the content item 123 or fingerprints as electronic files in one or more formats using platform data store 111.

In some implementations, content item 123 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some implementations, a video item can be stored (e.g., at platform data store 111) as a video file that includes a video component and an audio component. The video component can include video data that corresponds to one or more sequential video frames of the video item. The audio component can include audio data that corresponds to the video data.

As illustrated in FIG. 1, platform 120 can include a channel features recommendation engine 151. Channel features recommendation engine 151 can be configured to determine channel membership feature recommendations to be used in connection with a channel membership of a channel (e.g., the channel 121) of a channel owner of platform 120.

In some embodiments, channel features recommendation engine 151 can determine channel membership feature recommendations using one or more artificial intelligence (AI) models 160A-N. The channel membership feature recommendations engine 151 can feed a set of engagement signals and/or a set of channel membership features as input to a trained AI model 160. AI model 160 can be trained to predict, for a given set of engagement signals and/or a given set of channel membership features, a number of additional channel members that is predicted to be added to the channel membership upon integration of a respective channel membership feature of the plurality of channel membership features into the channel membership, in accordance with embodiments described herein.

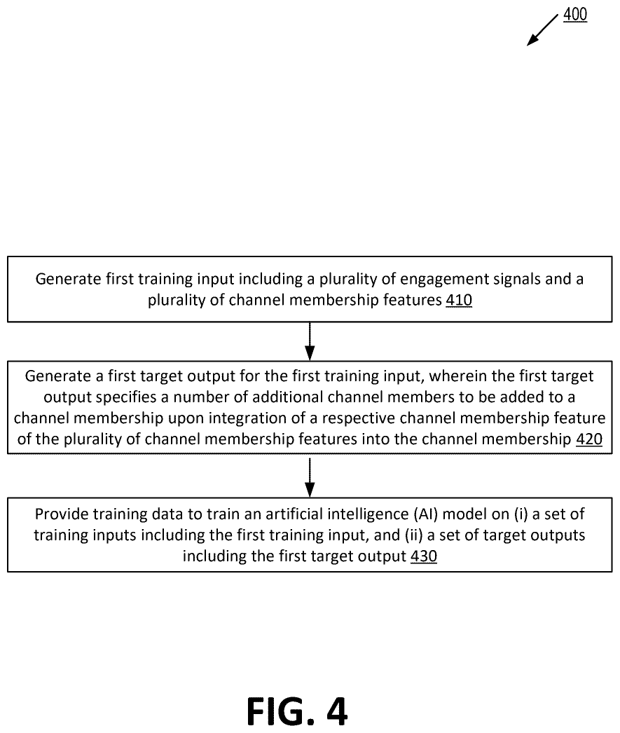

Training data generator 131 (i.e., residing at server machine 130) can generate training data to be used to train AI model 160. In some embodiments, training data generator 131 can generate the training data based on one or more engagement signals and/or one or more channel membership features (e.g., stored at data store 111 or another data store connected to system 100 via network 104). In an illustrative example, data store 111 can be configured to store a set of training engagement signals and/or channel membership features. In some embodiments, AI model 160 can be one or more generative, supervised, unsupervised, and/or semi-supervised machine learning models. In such embodiments, training data used to train model 160A-N can include a set of training inputs and a set of target outputs for the training inputs. Further detail with respect to the training of the model 160A-N is described with respect to FIG. 4.

Server machine 140 can include a training engine 141. Training engine 141 can train AI model 160A-N using the training data from training data generator 131. In some embodiments, the machine learning model 160A-N can refer to the model artifact that is created by the training engine 141 using the training data that includes training inputs and corresponding target outputs (correct answers for respective training inputs). The training engine 141 can find patterns in the training data that map the training input to the target output (the answer to be predicted), and provide the machine learning model 160A-N that captures these patterns. The machine learning model 160A-N can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model can be trained by, for example, adjusting weights of a neural network in accordance with a backpropagation learning algorithm or the like. In other or similar embodiments, the machine learning model 160A-N can refer to the model artifact that is created by training engine 141 using training data that includes training inputs. Training engine 141 can find patterns in the training data, identify clusters of data that correspond to the identified patterns, and provide the machine learning model 160A-N that captures these patterns. Machine learning model 160A-N can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), etc. Further details regarding generating training data and training machine learning model 160 are provided with respect to FIG. 4.

In some implementations, platform 120 and/or server machine(s) 130, 140, 150 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. Platform 120 can include channel 121. Channel 121 can be made accessible through platform 120. In some implementations, platform 120 can facilitate the access of channel 121, or information about channel 121 through channel user interface (UI) 125.

In some implementations, the functions of server machines 130, 140, 150, and/or platform 120 may be provided by a fewer number of machines. For example, in some implementations, components and/or modules of any of server machines 130, 140, 150 may be integrated into a single machine, while in other implementations components and/or modules of any of server machines 130, 140, 150 may be integrated into multiple machines. In addition, in some implementations, components and/or modules of any of server machines 130, 140, 150 may be integrated into platform 120.

In general, functions described in implementations as being performed by platform 120 and/or any of server machines 130, 140, 150 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

In situations in which the systems discussed here collect personal information about users, or may make use of personal information, the users may be provided with an opportunity to control whether platform 120 collects user information (e.g., information about a user's social network, social actions or activities, profession, a user's preferences, or a user's current location), or to control whether and/or how to receive content from the server 130 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the platform 120 and/or server 130.

In various implementations of the disclosure, a “user” can be represented by a single individual. However, other implementations of the disclosure encompass a “user” being an entity controlled by a group of individuals and/or an automated source. For example, a group of individuals federated as a community in a social network can be considered a “user.” Further to the descriptions above, a user can be provided with controls allowing the user to make an election as to both if and when systems, programs, or features described can enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

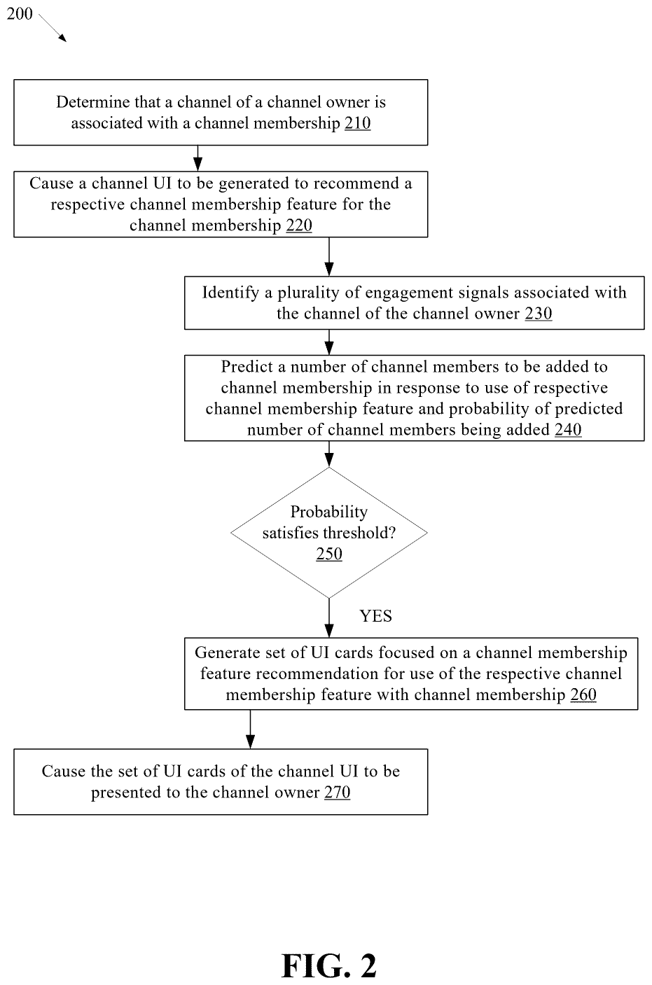

FIG. 2 depicts a flow diagram of a method for identifying, using artificial intelligence, channel feature recommendations for a channel membership on a content platform, in accordance with implementations of the present disclosure. Method 200 may be performed by processing logic that may include hardware (circuitry, dedicated logic, etc.), software (e.g., instructions run on a processing device), or a combination thereof. In one implementation, some or all the operations of method 200 may be performed by one or more components of system 100 of FIG. 1 (e.g., platform 120, server(s) 130, 140, 150, and/or channel features recommendation engine 151).

For simplicity of explanation, the method 200 of this disclosure is depicted and described as a series of acts. However, acts in accordance with this disclosure can occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events. Additionally, it should be appreciated that the method 200 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 210, the processing logic determines that a channel of a channel owner of a content platform (e.g., platform 120 of FIG. 1) is associated with a channel membership. In some implementations, the channel can be associated with content items (e.g., content item 123 of FIG. 1) and/or metadata (e.g., metadata 122 of FIG. 1). In some embodiments, the processing logic can determine that the channel of the channel owner is associated with the channel membership by retrieving the metadata of the channel (e.g., from the platform data store 111 of FIG. 1), where the metadata identifies that the channel includes the channel membership.

At block 220, the processing logic identifies a set of engagement signals associated with the channel of the channel owner. For example, the processing logic can retrieve the set of engagement signals from a data store associated with the platform 120 (e.g., the platform data store 111 of FIG. 1). In an illustrative example, the set of engagement signals can include the number of subscribers to a channel of the channel owner. In another illustrative example, the set of engagement signals can include a geographic region in which one or more subscribers of the channel resides. In another illustrative example, the set of engagement signals can include the age group of one or more subscribers of the channel. In another illustrative example, the set of engagement signals can include the content type of the channel owner (e.g., lifestyle, travel, cooking, etc.). In another illustrative example, the set of engagement signals can include the media type of the channel owner (e.g., livestream media, short form media, long form media, etc.). In another illustrative example, the set of engagement signals can include a geographic region in which the channel owner resides. In another illustrative example, the set of engagement signals can include an amount of watch time associated with the channel of the channel owner. In another illustrative example, the set of engagement signals can include one or more actions performed with respect to the set of channel membership features of the channel membership (e.g., the pre-existing channel membership features). For example, the one or more actions performed can include an action taken (e.g., by the channel and/or the channel owner) to provide the channel membership feature. For example, for a channel membership feature that is “channel members-only videos,” the action performed with respect to such channel membership feature can be the providing of a channel members-only video to the set of channel members of the channel membership.

At block 230, the processing logic feeds, as input to a trained artificial intelligence (AI) model, the set of engagement signals identified at block 220 and/or a set of channel membership features. In some embodiments, the set of channel membership features can include, for example, channel member loyalty badges, early access to content, channel members-only content, prioritization of channel owner's response to comments from channel members, channel members “shout-outs,” channel members status updates using media (e.g., images), channel members-only chat rooms, channel members-only social media connection with channel owner, channel members-only custom emojis, video collaborations between the channel owner and a channel member, virtual meet-and-greet between the channel owner and a channel member, exclusive merchandise, game play with the channel owner, behind-the-scenes content (e.g., videos), rough cuts and/or bloopers of content, wallpapers that are exclusive to one or more channels of the channel owner and/or channel owner, discounted merchandise of the channel owner, access to archived content (e.g., videos, livestreams, etc.), default channel member badges, channel members-only polls, etc. In some embodiments, the set of channel membership features can include a subset of the set of channel membership features that are pre-existing channel membership features for the channel membership of the channel of the channel owner (e.g., channel membership features that the channel member already provides to channel members of the channel membership). In some embodiments, the processing logic can retrieve the set of channel membership features from a data store associated with the platform 120 (e.g., the platform data store 111 of FIG. 1).

At block 240, the processing logic obtains one or more outputs from the trained AI model, the one or more outputs indicating a number of additional channel members that is predicted to be added to the channel membership upon integration of a respective channel membership feature of the set of channel membership features into the channel membership. Further details on the trained AI model are described with respect to FIG. 4.

At block 250, the processing logic determines, based on the one or more outputs from the trained AI model, a channel membership feature recommendation (e.g., a first channel membership feature recommendation) for the channel membership of the channel of the channel owner. In some embodiments, the first channel membership feature recommendation can include one or more additional channel membership features to provide (e.g., by the channel owner) for the channel membership, where providing the one or more additional channel membership features corresponds to an increase in a number of channel members of the channel membership. For example, the processing logic can identify the one or more channel membership feature recommendations that correspond to the highest number of additional channel members that would be added to the channel membership if the one or more channel membership feature recommendations is integrated into the channel membership. In some embodiments, the processing logic can determine another (e.g., a second) channel membership feature recommendation for the channel membership, where the second channel membership feature recommendation can include feedback on the existing channel features provided (e.g., by the channel owner) for the channel membership of the channel, such that the channel owner can select to continue providing one or more of the existing channel membership features or choose to remove one or more of the existing channel membership features (e.g., to maximize the revenue-driving parameters of the channel). In some embodiments, the processing logic can determine another (e.g., a third) channel membership feature recommendation for the channel membership, where the third channel membership feature recommendation can include channel membership revenue information for a set of channel membership features, such that the channel owner can select one or more of the set of channel membership features to integrate into the channel membership for the channel of the channel owner (e.g., to maximize the revenue-driving parameters of the channel).

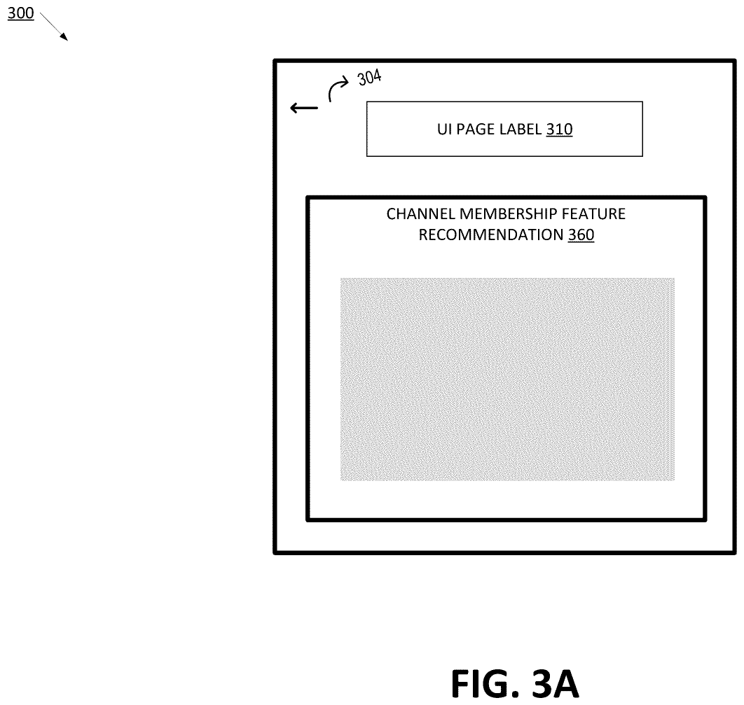

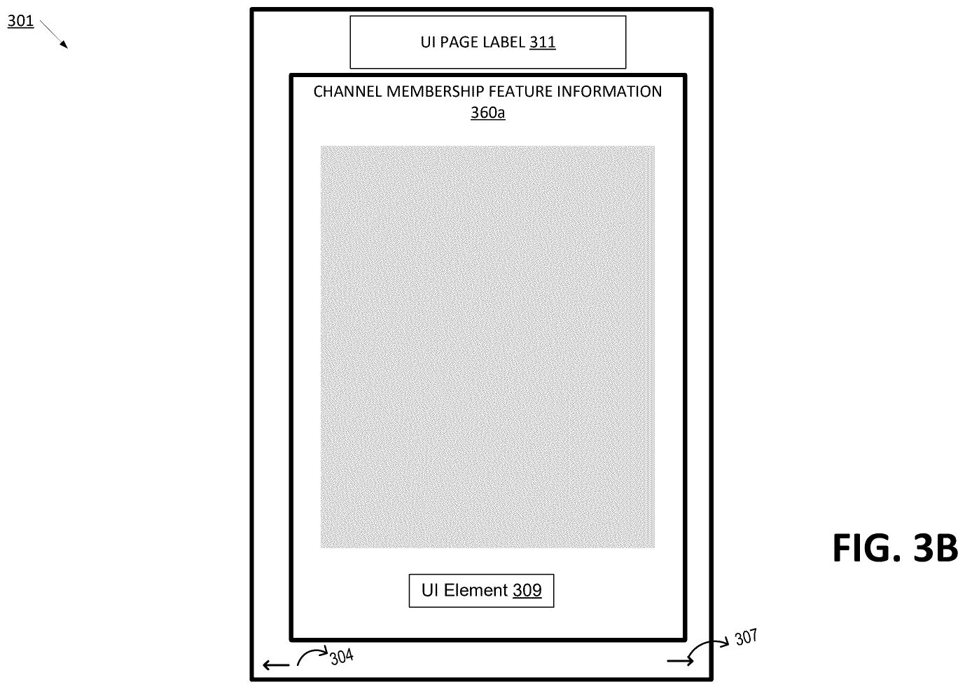

At block 260, the processing logic causes a channel user interface (UI) of the content sharing platform (e.g., the channel UI 125 of FIG. 1 and/or channel UI 300 of FIG. 3) to be presented to the channel owner. For example, causing the channel UI to be presented to the channel owner can include causing the channel membership feature recommendation determined at block 250 to be displayed for the channel membership of the channel. The channel owner can then select one or more UI elements of the channel UI to select the determined channel membership feature recommendation to modify one or more channel membership features (e.g., pre-existing channel membership features) for the channel membership of the channel of the channel owner, e.g., to integrate the selected determined channel membership feature recommendation into the channel membership. In some embodiments, the channel UI can be modified to display information about the selected channel membership feature recommendations, e.g., the information can include details and/or tips on how to integrate the selected channel membership feature recommendation into the channel membership.

In an illustrative example, referring to FIG. 3A, the processing logic can cause the channel UI 300 to be presented to the first channel owner. The channel UI 300 can include a UI page label 310 (e.g., an identifier of the UI page, such as “Channel Memberships,” “Memberships,” “Choose Channel Features,” “Choose Perks,” etc.), a UI element 304 (e.g., a back button that can be selectable to go back to a previous page in the channel UI 300), a display area for a channel membership feature recommendation 360, where information and/or an identifier of the channel membership feature recommendation 360 can be provided. In some embodiments, the channel owner can then select one or more UI elements of the channel UI to select the channel membership feature recommendation 360, e.g., to modify one or more channel membership features (e.g., pre-existing channel membership features) for the channel membership of the channel of the channel owner (e.g., to integrate the selected channel membership feature recommendation 360 into the channel membership).

In some embodiments, in an illustrative example, referring to FIG. 3B, in response to receiving a selection of the channel membership feature recommendation (e.g., in the channel UI 300 of FIG. 3A), the processing logic can cause the channel UI 301 to be presented to the channel owner. The channel UI 301 can display information about the selected channel membership feature recommendation 360, where the information can include details and/or tips on how to integrate the selected channel membership feature recommendation into the channel membership. The channel UI 300 can include a UI page label 311 (e.g., an identifier of the UI page) a UI element 304 (e.g., a back button that can be selectable to go back to a previous page in the channel UI 300), a UI element 307 (e.g., a forward button that can be selectable to go forward to a subsequent page in the channel UI 301), a display area for information pertaining to the selected channel membership feature recommendation 360a, and/or a UI element 309 that can be selectable to modify the channel membership to include the selected channel membership feature recommendation 360a into the channel membership.

FIG. 3A is a block diagram illustrating an example channel user interface (UI), in accordance with implementations of the present disclosure. FIG. 3A is described with respect to FIG. 2 herein above.

FIG. 3B is a block diagram illustrating an example channel user interface (UI), in accordance with implementations of the present disclosure. FIG. 3B is described with respect to FIG. 2 herein above.

FIG. 4 depicts a flow diagram of a method for training an artificial intelligence (AI) model, in accordance with implementations of the present disclosure. Method 400 may be performed by processing logic that may include hardware (circuitry, dedicated logic, etc.), software (e.g., instructions run on a processing device), or a combination thereof. In one implementation, some or all the operations of method 400 may be performed by one or more components of system 100 of FIG. 1.

Referring now to FIG. 4, at block 410, the processing logic generates first training input. In some embodiments, the first training input includes one or more engagement signals and/or one or more channel membership features. In some embodiments, the one or more engagement signals can include the number of subscribers to a channel of the channel owner, a geographic region in which one or more subscribers of the channel resides, the age group of one or more subscribers of the channel, the content type of the channel owner (e.g., lifestyle, travel, cooking, etc.), the media type of the channel owner (e.g., livestream media, short form media, long form media, etc.), etc. In another illustrative example, the set of engagement signals can include a geographic region in which the channel owner resides. In another illustrative example, the set of engagement signals can include an amount of watch time associated with the channel of the channel owner. In another illustrative example, the set of engagement signals can include one or more actions performed with respect to the set of channel membership features of the channel membership (e.g., the pre-existing channel membership features). For example, the one or more actions performed can include an action taken (e.g., by the channel and/or the channel owner) to provide the channel membership feature. For example, for a channel membership feature that is “channel members-only videos,” the action performed with respect to such channel membership feature can be the providing of a channel members-only video to the set of channel members of the channel membership. In some embodiments, each engagement signal can be assigned a weight value. For example, the processing logic can assign a weight value to each engagement signal of the set of engagement signals. In some embodiments, the weight value can be assigned to each engagement signal based on experimental testing using User Experience Research (“UXR”) studies with channel owners and/or subscribers, where channel owners are asked during the UXR studies to rank and/or assign a weight value to specific channel features based on what they consider most to least difficult and/or based on what they consider to require the most to least amount of effort. Additionally, or alternatively, subscribers can be asked during the UXR studies to state subjectively how they view a particular channel feature and how much the subscribers would pay (e.g., as a fee) for access to the channel feature. Upon assigning the weight values to each engagement signal of the set of engagement signals, the processing logic can rank each engagement signal of the set of engagement signals according to the weighted values of respective engagement signals. The ranked engagement signals can be provided as training input to the AI model.

In some embodiments, the set of channel membership features can include, for example, channel member loyalty badges, early access to content, channel members-only content, prioritization of channel owner's response to comments from channel members, channel members “shout-outs,” channel members status updates using media (e.g., images), channel members-only chat rooms, channel members-only social media connection with channel owner, channel members-only custom emojis, video collaborations between the channel owner and a channel member, virtual meet-and-greet between the channel owner and a channel member, exclusive merchandise, game play with the channel owner, behind-the-scenes content (e.g., videos), rough cuts and/or bloopers of content, wallpapers that are exclusive to one or more channels of the channel owner and/or channel owner, discounted merchandise of the channel owner, access to archived content (e.g., videos, livestreams, etc.), default channel member badges, channel members-only polls, etc. In some embodiments, the set of channel membership features can include a subset of the set of channel membership features that are pre-existing channel membership features for the channel membership of the channel of the channel owner (e.g., channel membership features that the channel member already provides to channel members of the channel membership).

At block 420, the processing device generates a first target output for the first training input, wherein the first target output predicts, for the given set of engagement signals and/or the given set of channel membership features, a number of additional channel members that is predicted to be added to the channel membership upon integration of a respective channel membership feature of the plurality of channel membership features into the channel membership.

At block 430, the processing device provides the training data to train an artificial intelligence (AI) model (e.g., the model 160A-N of FIG. 1) on (i) a set of training inputs including the first training input, and (ii) a set of target outputs including the first target output. In some embodiments, each training input of the set of training inputs is mapped to a target output in the set of target outputs.

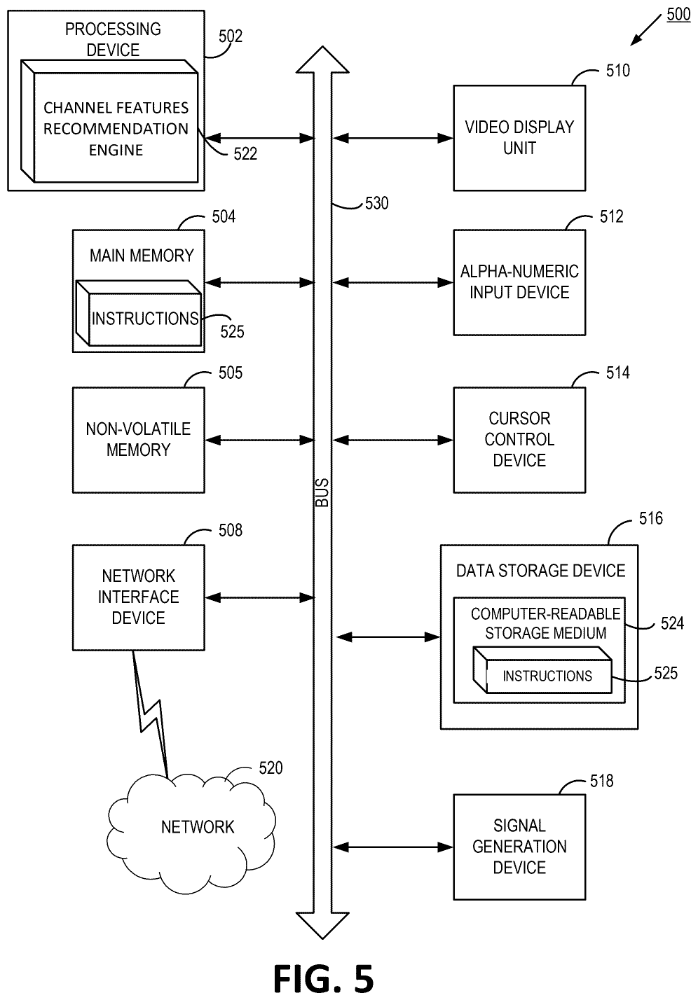

FIG. 5 is a block diagram illustrating an exemplary computer system, in accordance with implementations of the present disclosure. The computer system 500 can be the server(s) 130, 140, and/or 150 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 518, which communicate with each other via a bus 540.

Processor (processing device) 502 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 505 (e.g., for identifying, using artificial intelligence, channel feature recommendations for a channel membership on a content platform) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 520 (e.g., a speaker).

The data storage device 518 can include a non-transitory machine-readable storage medium 524 (also computer-readable storage medium) on which is stored one or more sets of instructions 505 (e.g., for identifying, using artificial intelligence, channel feature recommendations for a channel membership on a content platform) embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 530 via the network interface device 508.

In one implementation, the instructions 505 include instructions for identifying, using artificial intelligence, channel feature recommendations for a channel membership on a content platform. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
determining, by a processing device of a content sharing platform, that a channel of a channel owner is associated with a channel membership;
identifying a plurality of engagement signals associated with the channel of the channel owner;
feeding, as input to a trained artificial intelligence (AI) model, the plurality of engagement signals and a plurality of channel membership features;
obtaining one or more outputs from the trained AI model, the one or more outputs indicating a number of additional channel members that is predicted to be added to the channel membership upon integration of a respective channel membership feature of the plurality of channel membership features into the channel membership;
determining, based on the one or more outputs from the trained AI model, a first channel membership feature recommendation for the channel membership; and
causing a channel user interface (UI) of the content sharing platform to be presented to the channel owner, the channel UI providing the first channel membership feature recommendation for the channel membership of the channel.

2. The method of claim 1, wherein causing the channel UI to be presented to the channel owner further comprises:
causing the first channel membership feature recommendation to be displayed for the channel membership; and
receiving a selection of one or more UI elements of the channel UI by the channel owner, wherein the one or more UI elements are selectable to modify one or more channel membership features for the channel membership based on the first channel membership feature recommendation.

3. The method of claim 1, further comprising:
assigning a weight value to each engagement signal of the plurality of engagement signals; and
determining, based on the weight value assigned to each engagement signal of the plurality of engagement signals, a respective ranking.

4. The method of claim 1, wherein the plurality of engagement signals comprises at least one or more of: a number of channel subscribers, a number of views of the channel, a type of channel content, a geographic location of one or more subscribers associated with the channel owner, a geographic location of the channel owner, an amount of watch time associated with the channel, or one or more actions performed with respect to the plurality of channel features of the channel membership.

5. The method of claim 1, further comprising:
determining, based on the one or more outputs from the trained AI model, a second channel membership feature recommendation for the channel membership, wherein the second channel membership feature recommendation comprises a feedback on one or more of the plurality of channel membership features of the channel membership; and
causing the channel UI to provide the second channel membership feature recommendation for the channel membership.

6. The method of claim 1, further comprising:
determining, based on the one or more outputs from the trained AI model, a third channel membership feature recommendation for the channel membership, wherein the third channel membership feature recommendation comprises channel membership revenue information for one or more of the plurality of channel membership features of the channel membership; and
causing the channel UI to provide the third channel membership feature recommendation for the channel membership.

7. The method of claim 1, wherein the first channel membership feature recommendation comprises one or more additional channel membership features to provide for the channel membership, wherein the one or more additional channel membership features correspond to an increase in channel members of the channel membership.

8. A system comprising:
a memory device; and
a processing device coupled to the memory device, the processing device to perform operations comprising:
determining that a channel of a channel owner of a content sharing platform is associated with a channel membership;
identifying a plurality of engagement signals associated with the channel of the channel owner;
feeding, as input to a trained artificial intelligence (AI) model, the plurality of engagement signals and a plurality of channel membership features;
obtaining one or more outputs from the trained AI model, the one or more outputs indicating a number of additional channel members that is predicted to be added to the channel membership upon integration of a respective channel membership feature of the plurality of channel membership features into the channel membership;
determining, based on the one or more outputs from the trained AI model, a first channel membership feature recommendation for the channel membership; and
causing a channel user interface (UI) of the content sharing platform to be presented to the channel owner, the channel UI providing the first channel membership feature recommendation for the channel membership of the channel.

9. The system of claim 8, wherein to cause the channel UI to be presented to the channel owner, the processing device is to perform operations further comprising:
causing the first channel membership feature recommendation to be displayed for the channel membership; and
receiving a selection of one or more UI elements of the channel UI by the channel owner, wherein the one or more UI elements are selectable to modify one or more channel membership features for the channel membership based on the first channel membership feature recommendation.

10. The system of claim 8, wherein the processing device is to perform operations further comprising:
assigning a weight value to each engagement signal of the plurality of engagement signals; and
determining, based on the weight value assigned to each engagement signal of the plurality of engagement signals, a respective ranking.

11. The system of claim 8, wherein the plurality of engagement signals comprises at least one or more of: a number of channel subscribers, a number of views of the channel, a type of channel content, a geographic location of one or more subscribers associated with the channel owner, a geographic location of the channel owner, an amount of watch time associated with the channel, or one or more actions performed with respect to the plurality of channel features of the channel membership.

12. The system of claim 8, wherein the processing device is to perform operations further comprising:
determining, based on the one or more outputs from the trained AI model, a second channel membership feature recommendation for the channel membership, wherein the second channel membership feature recommendation comprises a feedback on one or more of the plurality of channel membership features of the channel membership; and
causing the channel UI to provide the second channel membership feature recommendation for the channel membership.

13. The system of claim 8, wherein the processing device is to perform operations further comprising:
determining, based on the one or more outputs from the trained AI model, a third channel membership feature recommendation for the channel membership, wherein the third channel membership feature recommendation comprises channel membership revenue information for one or more of the plurality of channel membership features of the channel membership; and
causing the channel UI to provide the third channel membership feature recommendation for the channel membership.

14. The system of claim 8, wherein the first channel membership feature recommendation comprises one or more additional channel membership features to provide for the channel membership, wherein the one or more additional channel membership features correspond to an increase in channel members of the channel membership.

15. A non-transitory computer readable storage medium comprising instructions for a server that, when executed by a processing device, cause the processing device to perform operations comprising:
determining that a channel of a channel owner of a content sharing platform is associated with a channel membership;
identifying a plurality of engagement signals associated with the channel of the channel owner;
feeding, as input to a trained artificial intelligence (AI) model, the plurality of engagement signals and a plurality of channel membership features;
obtaining one or more outputs from the trained AI model, the one or more outputs indicating a number of additional channel members that is predicted to be added to the channel membership upon integration of a respective channel membership feature of the plurality of channel membership features into the channel membership;
determining, based on the one or more outputs from the trained AI model, a first channel membership feature recommendation for the channel membership; and
causing a channel user interface (UI) of the content sharing platform to be presented to the channel owner, the channel UI providing the first channel membership feature recommendation for the channel membership of the channel.

16. The non-transitory computer readable storage medium of claim 15, wherein to cause the channel UI to be presented to the channel owner, the processing device is to perform operations further comprising:
causing the first channel membership feature recommendation to be displayed for the channel membership; and
receiving a selection of one or more UI elements of the channel UI by the channel owner, wherein the one or more UI elements are selectable to modify one or more channel membership features for the channel membership based on the first channel membership feature recommendation.

17. The non-transitory computer readable storage medium of claim 15, wherein the processing device is to perform operations further comprising:
assigning a weight value to each engagement signal of the plurality of engagement signals; and
determining, based on the weight value assigned to each engagement signal of the plurality of engagement signals, a respective ranking.

18. The non-transitory computer readable storage medium of claim 15, wherein the plurality of engagement signals comprises at least one or more of: a number of channel subscribers, a number of views of the channel, a type of channel content, a geographic location of one or more subscribers associated with the channel owner, a geographic location of the channel owner, an amount of watch time associated with the channel, or one or more actions performed with respect to the plurality of channel features of the channel membership.

19. The non-transitory computer readable storage medium of claim 15, wherein the processing device is to perform operations further comprising:
determining, based on the one or more outputs from the trained AI model, a second channel membership feature recommendation for the channel membership, wherein the second channel membership feature recommendation comprises a feedback on one or more of the plurality of channel membership features of the channel membership; and
causing the channel UI to provide the second channel membership feature recommendation for the channel membership.

20. The non-transitory computer readable storage medium of claim 15, wherein the processing device is to perform operations further comprising:
determining, based on the one or more outputs from the trained AI model, a third channel membership feature recommendation for the channel membership, wherein the third channel membership feature recommendation comprises channel membership revenue information for one or more of the plurality of channel membership features of the channel membership; and
causing the channel UI to provide the third channel membership feature recommendation for the channel membership.
